(19) United States
(12) Patent Application Publication
(10) Pub. No.: US 2016/0154603 A1
(43) Pub. Date: Jun. 2, 2016

(54) DATA TRANSFER CONTROL DEVICE, APPARATUS INCLUDING THE SAME, AND DATA TRANSFER CONTROL METHOD

(71) Applicant: Taichi Yoshioka, Kanagawa (JP)

(72) Inventor: Taichi Yoshioka, Kanagawa (JP)

(73) Assignee: Ricoh Company, Ltd., Tokyo (JP)

(21) Appl. No.: 14/949,832

(22) Filed: Nov. 23, 2015

(30) Foreign Application Priority Data
Nov. 27, 2014 (JP) 2014240507

(51) Int. Cl. G06F 3/06

(52) U.S. Cl. CPC G06F 3/0631; G06F 3/0604; G06F 3/0647; G06F 3/0671

(57) ABSTRACT

A data transfer control device includes a memory, at least a first DMA controller, and an area allocation unit. The first DMA controller requests to allocate a memory area in the memory to the first DMA controller in response to an instruction to perform linked data transfer with a second DMA controller via the memory. The first DMA controller and the second DMA controller are different from each other. The area allocation unit allocates a memory area in the memory to the first DMA controller in accordance with the request to allocate from the first DMA controller. The first DMA controller allocated with the memory area in the memory performs the linked data transfer with the second DMA controller via the allocated memory area in the memory in accordance with respective operating states of the first DMA controller and the second DMA controller.

### CROSS-REFERENCE TO RELATED APPLICATION

This patent application is based on and claims priority pursuant to 35 U.S.C. §119(a) to Japanese Patent Application No. 2014-240507 on Nov. 27, 2014, in the Japan Patent Office, the entire disclosure of which is hereby incorporated by reference herein.

### BACKGROUND

1. Technical Field

This disclosure relates to a data transfer control device, an apparatus including the data transfer control device, and a data transfer control method.

2. Related Art

In recent years, a system having multiple functional modules connected via a bus arbiter, such as an information processing apparatus like a personal computer (PC) or an image forming apparatus, has commonly used direct memory access (DMA) to allow the functional modules to directly access a memory without involvement of a central processing unit (CPU). Such DMA is a technique executed by a direct memory access controller (DMA controller or DMAC) to reduce the processing load and increase the processing speed in a system as a whole.

An applied technique of the DMA is DMAC linkage that operates multiple DMACs in a linked fashion. For example, according to the DMAC linkage, data is read from a memory by a read DMAC (RDMAC), subjected to a predetermined process, and written back to the memory by a write DMAC (WDMAC). The DMAC linkage technique is intended to reduce memory usage and simplify the control of a software program, for example.

### SUMMARY

In one embodiment of this disclosure, there is provided an improved data transfer control device that includes, for example, a memory, at least a first direct memory access controller, and an area allocation unit. The first direct memory access controller requests to allocate a memory area in the memory to the first direct memory access controller in response to an instruction to perform linked data transfer with a second direct memory access controller via the memory. The first direct memory access controller and the second direct memory access controller are different from each other. The area allocation unit allocates a memory area in the memory to the first direct memory access controller in accordance with the request to allocate from the first direct memory access controller. The first direct memory access controller allocated with the memory area in the memory performs the linked data transfer with the second direct memory access controller via the allocated memory area in the memory in accordance with respective operating states of the first direct memory access controller and the second direct memory access controller.

In one embodiment of this disclosure, there is provided an improved apparatus that includes the above-described data transfer control device.

In one embodiment of this disclosure, there is provided an improved data transfer control method performed by a data transfer control device including a memory, at least a first direct memory access controller, and an area allocation unit. The data transfer control method includes transmitting from the first direct memory access controller to the area allocation unit a request to allocate a memory area in the memory to the first direct memory access controller in response to an instruction to perform linked data transfer between the first direct memory access controller and a second direct memory access controller via the memory, the first direct memory access controller and the second direct memory access controller being different from each other, allocating a memory area in the memory to the first direct memory access controller in accordance with the request to allocate a memory area in the memory, and performing the linked data transfer between the first direct memory access controller and the second direct memory access controller via the memory area allocated to the first direct memory access controller in accordance with respective operating states of the first direct memory access controller and the second direct memory access controller.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a hardware configuration of a control system of an image forming apparatus according to an embodiment of this disclosure;

FIG. 2 is a diagram illustrating data flow in DMAC linkage performed by the image forming apparatus according to the embodiment;

FIG. 3 is a diagram illustrating an example of DMAC linkage buffers set in an ASIC memory according to the embodiment;

FIG. 4 is a diagram illustrating an example of combinations of modules that perform the DMAC linkage in a controller ASIC according to the embodiment; and

FIG. 5 is a flowchart illustrating a process of allocating a DMAC linkage buffer performed by the image forming apparatus according to the embodiment.

The accompanying drawings are intended to depict example embodiments of the present disclosure and should not be interpreted to limit the scope thereof The accompanying drawings are not to be considered as drawn to scale unless explicitly noted.

### DETAILED DESCRIPTION

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same function, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Referring now to the drawings, wherein like reference numerals designate identical or corresponding parts throughout the several views, an embodiment of this disclosure will be described in detail.

An image forming apparatus in which multiple functional modules are connected via a bus arbiter to perform direct memory access (DMA) will be described as an example of the embodiment. The DMA is performed by direct memory access controllers (DMA controllers or DMACs) to reduce the processing load and increase the processing speed in the entire system of the image forming apparatus.

In the image forming apparatus according to the embodiment, the functional modules access a memory in accordance with DMAC linkage that operates multiple DMACs in a linked fashion. For example, according to the DMAC linkage, data is read from the memory by a read DMAC, subjected to a predetermined process, and written back to the memory by a write DMAC. That is, in the image forming apparatus according to the embodiment, different DMACs perform linked data transfer therebetween via the memory while monitoring the operating state of each other.

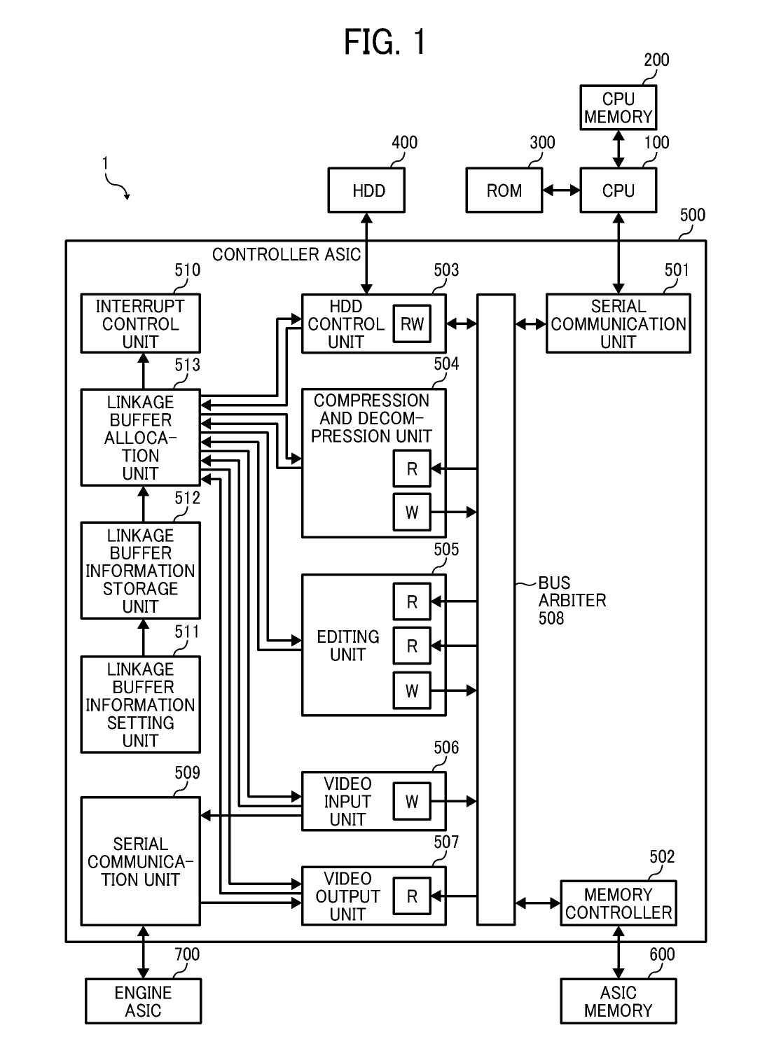

A hardware configuration of an image forming apparatus 1 according to the embodiment will first be described with reference to FIG. 1.

FIG. 1 is a schematic block diagram illustrating a hardware configuration of a control system of the image forming apparatus 1 according to the embodiment. In FIG. 1, R represents a read DMAC (RDMAC) dedicated to data reading, and W represents a write DMAC (WDMAC) dedicated to data writing. Further, RW represents a read-write DMAC (RWDMAC) switchable between data reading and data writing.

As illustrated in FIG. 1, the control system of the image forming apparatus 1 according to the embodiment includes a central processing unit (CPU) 100, a CPU memory 200, a read-only memory (ROM) 300, a hard disk drive (HDD) 400, a controller application specific integrated circuit (ASIC) 500, an ASIC memory 600, and an engine ASIC 700.

The CPU 100 is an arithmetic device that controls an overall operation of the image forming apparatus 1 in accordance with a software program stored in the ROM 300, the HDD 400, or a storage medium such as an optical disc.

The CPU memory 200 connected to the CPU 100 is a volatile storage medium capable of reading and writing information at high speed. The CPU memory 200 is used to temporarily store data or serve as a work area in information processing by the CPU 100. The CPU memory 200 is implemented by a large-capacity memory such as a double-data-rate3 synchronous dynamic RAM (DDR3-SDRAM).

The ROM 300 is a non-volatile storage medium dedicated to data reading, and stores programs such as firmware.

The HDD 400 is a non-volatile storage device capable of reading and writing information, and stores various data such as image data, an operating system (OS), and various programs such as control programs and application programs.

The controller ASIC 500 is controlled by the CPU 100 to perform a decompression process on coded data stored in the CPU memory 200 and output the decompressed data to the engine ASIC 700 or perform a compression process on image data input from the engine ASIC 700 and store the compressed data in the CPU memory 200. That is, in the embodiment, the controller ASIC 500 functions as a data transfer control device.

The controller ASIC 500 includes a serial communication unit 501, a memory controller 502, an HDD control unit 503, a compression and decompression unit 504, an editing unit 505, a video input unit 506, and a video output unit 507, which are connected via a bus arbiter 508. The controller ASIC 500 further includes a serial communication unit 509, an interrupt control unit 510, a linkage buffer information setting unit 511, a linkage buffer information storage unit 512, and a linkage buffer allocation unit 513.

The serial communication unit 501 is an interface (I/F) for connecting the CPU 100 and the controller ASIC 500, and is implemented by a high-speed serial I/F such as peripheral component interconnect express (PCIe).

The memory controller 502 controls memory access of the controller ASIC 500 to the ASIC memory 600. The memory controller 502 connects the controller ASIC 500 and the ASIC memory 600 with an I/F having a data transfer speed faster than that of the serial communication unit 501, thereby improving data transfer performance.

Further, while the design of memory access of the controller ASIC 500 to the CPU memory 200 depends on the CPU 100, which is normally a general-purpose CPU, the design of memory access of the controller ASIC 500 to the ASIC memory 600 does not have such a restriction, and thus has a high degree of design freedom.

The HDD control unit 503 includes a RWDMAC, and controls data reading from the HDD 400 and data writing to the HDD 400.

The compression and decompression unit 504 includes a RDMAC and a WDMAC. The compression and decompression unit 504 reads image data or compressed data from the CPU memory 200 or the ASIC memory 600 with the RDMAC, performs a compression process or a decompression process on the read data, and writes the processed data to the CPU memory 200 or the ASIC memory 600 with the WDMAC.

The editing unit 505 includes a WDMAC and two RDMACs. The editing unit 505 reads image data from the CPU memory 200 or the ASIC memory 600 with the RDMACs, performs an editing process on the read image data, and writes the processed data to the CPU memory 200 or the ASIC memory 600 with the WDMAC.

For example, the editing unit 505 reads two image data items (e.g., an image and a stamp or an image and a pattern) from the CPU memory 200 or the ASIC memory 600 with the two RDMACs, performs a process such as synthesizing the two image data items or trimming the image data read by the RDMACs, and writes the processed data to the CPU memory 200 or the ASIC memory 600 with the WDMAC.

The video input unit 506 includes a WDMAC. The video input unit 506 receives image data generated by the engine ASIC 700 and input to the video input unit 506 in units of lines via the serial communication unit 509, and sequentially writes the image data to the CPU memory 200 or the ASIC memory 600 with the WDMAC.

In this process, the data is input to the video input unit 506 from a scanner engine, for example, at regular intervals such that one line of data is transferred in each data transfer. Since the scanner engine continues to operate even if the data transfer is delayed, the video input unit 506 is required to transfer one line of data within a predetermined time. Accordingly, the video input unit 506 is configured to ensure isochronous transfer of lines of data.

The video output unit 507 includes a RDMAC. The video output unit 507 reads image data in units of lines from the CPU memory 200 or the ASIC memory 600 with the RDMAC, and sequentially outputs the image data to the engine ASIC 700 via the serial communication unit 509.

In this process, the video output unit 507 outputs the data to a print engine, for example, at regular intervals such that one line of data is transferred in each data transfer. Since the print engine continues to operate even if the data transfer is delayed, the video output unit 507 is required to transfer one line of data within a predetermined time. Accordingly, the video output unit 507 is configured to ensure isochronous transfer of lines of data similarly to the video input unit 506.

Each of the RDMACs and WDMACs in the compression and decompression unit 504, the editing unit 505, and the video input unit 506, and the video output unit 507 is capable of selecting which one of the CPU memory 200 and the ASIC memory 600 to access.

The bus arbiter 508 controls the access order by arbitrating requests to access the CPU memory 200 or the ASIC memory 600 received from bus masters connected to a bus. The bus arbiter 508 is configured to preferentially arbitrate access requests from bus masters that need to reliably perform isochronous transfer of lines of data, such as the video input unit 506 and the video output unit 507, to ensure isochronous transfer of lines of data.

The serial communication unit 509 is an OF for connecting the controller ASIC 500 and the engine ASIC 700, and is implemented by a high-speed serial OF such as PCIe.

If any of the modules in the controller ASIC 500 notifies the interrupt control unit 510 of an interrupt factor, the interrupt control unit 510 generates an interrupt and notifies the CPU 100 of the interrupt via the serial communication unit 501.

The linkage buffer information setting unit 511, the linkage buffer information storage unit 512, and the linkage buffer allocation unit 513 will be described later.

The ASIC memory 600 temporarily stores intermediate data, which includes image data obtained by a decompression process performed by the controller ASIC 500 on coded data read from the CPU memory 200 and coded data obtained by a compression process performed by the controller ASIC 500 on image data input from the engine ASIC 700.

The engine ASIC 700 performs image processing, such as shading correction, dot correction, γ correction, color space conversion, or scaling, on read data generated from optical scanning of a document by the scanner engine, and inputs the processed data to the controller ASIC 500.

Further, the engine ASIC 700 performs image processing, such as rotation, compression, decompression, scaling, or gradation adjustment, on image data input from the controller ASIC 500, to thereby generate render data for rendering an image to be formed in an image forming operation by the print engine.

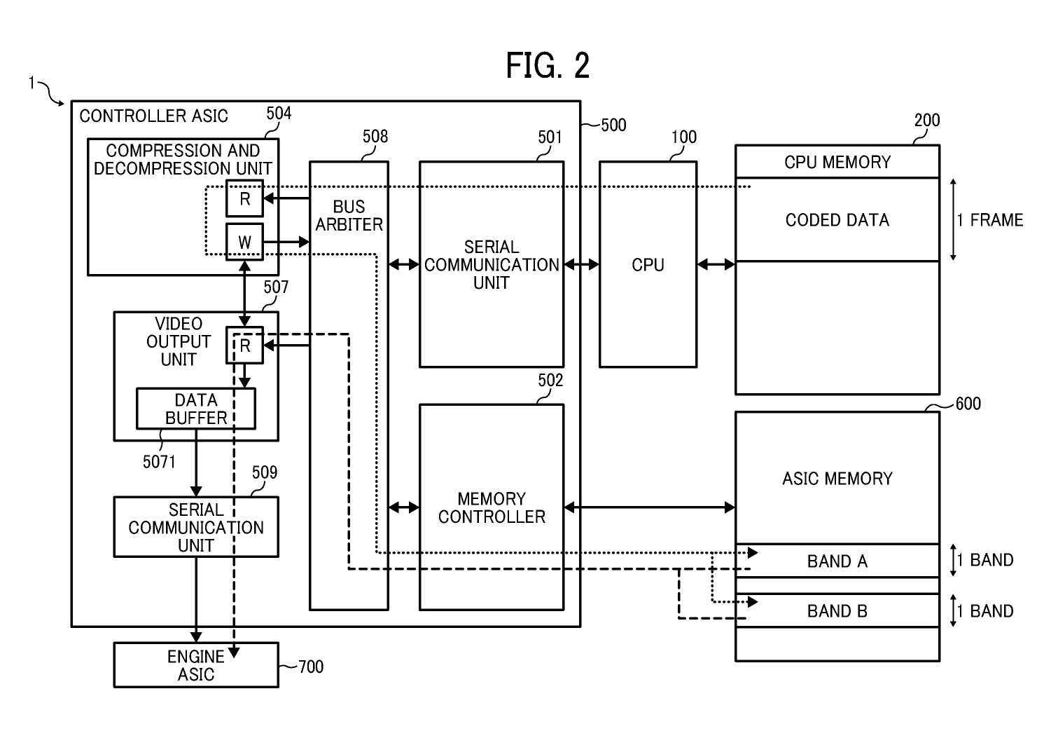

A process of DMAC linkage performed by the image forming apparatus 1 according to the embodiment will now be described with reference to FIG. 2.

FIG. 2 is a diagram illustrating data flow in the DMAC linkage performed by the image forming apparatus 1 according to the embodiment. FIG. 2 illustrates DMAC linkage in a process of decompressing coded data stored in the CPU memory 200 and outputting the decompressed data to the engine ASIC 700, i.e., DMAC linkage in print output.

As illustrated in FIG. 2, in the DMAC linkage performed by the image forming apparatus 1 according to the embodiment, the compression and decompression unit 504 first reads one page of coded data from the CPU memory 200 via the CPU 100 and the serial communication unit 501 with the RDMAC thereof.

The compression and decompression unit 504 then performs a decompression process on the coded data read from the CPU memory 200 to obtain image data, and writes the image data to the ASIC memory 600 with the WDMAC thereof, as indicated by dotted lines in FIG. 2.

After the image data is written to the ASIC memory 600, the video output unit 507 reads the image data from the ASIC memory 600 with the RDMAC thereof. The video output unit 507 then writes the read image data to a data buffer 5071, and at the same time, outputs the image data to the engine ASIC 700 via the serial communication unit 509 in the order of writing the image data, as indicated by broken lines in FIG. 2.

Roles of the data buffer 5071 in the video output unit 507 will now be described.

The data transfer speed in the output of image data to the engine ASIC 700 from the video output unit 507 via the serial communication unit 509 is lower than the data transfer speed in the reading of image data from the ASIC memory 600.

If the image data read from the ASIC memory 600 is directly output to the engine ASIC 700 via the serial communication unit 509 by the video output unit 507, therefore, the output of image data fails to keep pace with the reading of image data, resulting in overflow of image data.

The data buffer 5071 is provided to prevent such overflow of image data, i.e., to store image data that would otherwise overflow. In other words, the data buffer 5071 is provided to address the difference between the data transfer speed at which the video output unit 507 outputs the image data to the engine ASIC 700 via the serial communication unit 509 and the data transfer speed at which the video output unit 507 reads the image data from the ASIC memory 600.

If all of one page of decompressed image data is written to the ASIC memory 600 and thereafter is read out, the memory consumption of the ASIC memory 600 is increased. Further, in this case, the image data is output to the engine ASIC 700 only after all of one page of image data is written to the ASIC memory 600, which degrades the productivity of print output.

As illustrated in FIG. 2, therefore, the image forming apparatus 1 according to the embodiment is configured to manage one page of image data as divided in band units and write data to or read data from respective band areas (e.g., bands A and B in FIG. 2) under toggle control. Accordingly, the image forming apparatus 1 according to the embodiment reduces the memory consumption of the ASIC memory 600 and improves the productivity of print output.

Further, in the image forming apparatus 1 according to the embodiment, the toggle control is executed by hardware, and the software program simply sets the DMACs in a linkage mode and actives the DMACs. In the image forming apparatus 1 according to the embodiment, therefore, the control of the software program is simplified. Further, the DMACs set in the linkage mode are configured to monitor the operation progress of one another and notify one another of the operating state thereof to prevent a change in the order of data transfer.

Further, the controller ASIC 500 according to the embodiment is connected to the CPU memory 200 and the ASIC memory 600. Since each of the DMACs accesses the CPU memory 200 via the CPU 100 and the serial communication unit 501, the speed of access to the CPU memory 200 is lower than the speed of access to the ASIC memory 600.

If the controller ASIC 500 were connected only to the CPU memory 200 and not to the ASIC memory 600, therefore, the image forming apparatus 1 would need to increase the number of access requests transmitted before the receipt of requested data by adopting a split transaction bus in order to prevent performance degradation due to a decrease in the speed of access to the CPU memory 200. Such an increase in the number of access requests transmitted before the receipt of requested data, however, complicates the circuit of the controller ASIC 500. Further, in this case, accesses may concentrate on the CPU memory 200, forcing some of the DMACs having transmitted the access requests to wait until the communication band of the serial communication unit 501 becomes available. Consequently, the data transfer performance in the controller ASIC 500 is degraded.

Such degraded data transfer performance in the controller ASIC 500 may be prevented if the modules in the controller ASIC 500 are directly connected to one another to transfer data not via the bus arbiter 508 and the CPU memory 200.

The direct connection between the modules in the controller ASIC 500, however, needs to be made in consideration of all possible data transfer paths in the controller ASIC 500, which complicates wiring.

Further, if the controller ASIC 500 were connected only to the CPU memory 200 and not to the ASIC memory 600, data reading from the CPU memory 200 by the video output unit 507 may be temporarily delayed owing to factors such as data retransmission via the serial communication unit 501 and arbitration of access requests by the CPU 100. In this case, therefore, system designing for avoiding the above-described factors is required. However, such system designing is complicated.

Further, the video output unit 507 is configured to ensure isochronous transfer of lines of data, as described above. In this case, therefore, the video output unit 507 needs to include a large-capacity data buffer capable of holding at least one line of data in case of delay in data reading from the CPU memory 200 to prevent the delay from affecting the data transfer in the one-line cycle time.

The image forming apparatus 1 according to the embodiment addresses the above-described issues by connecting the ASIC memory 600 to the controller ASIC 500.

That is, with the ASIC memory 600 connected to the controller ASIC 500, the image forming apparatus 1 according to the embodiment addresses the complication of the circuit of the controller ASIC 500 due to the increase in the number of access requests transmitted before the receipt of requested data, the degraded data transfer performance due to the concentration of accesses on the CPU memory 200, the complication of wiring due to the direct connection between the modules, the complication of system designing for ensuring isochronous transfer of lines of data, and the increase in the capacity of the data buffer for ensuring isochronous transfer of lines of data.

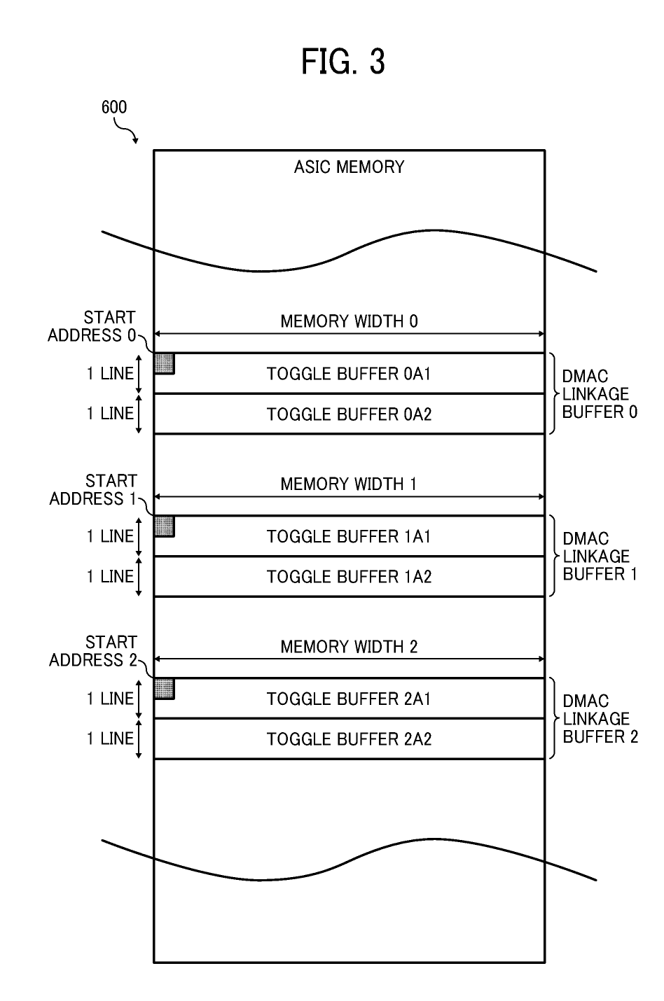

An example of memory areas for the DMAC linkage (hereinafter referred to as the DMAC linkage buffers) set in the ASIC memory 600 according to the embodiment will now be described with reference to FIG. 3.

FIG. 3 is a diagram illustrating an example of the DMAC linkage buffers set in the ASIC memory 600 according to the embodiment. FIG. 3 illustrates an example in which three DMAC linkage buffers (i.e., DMAC linkage buffers 0, 1, and 2) are set.

As illustrated in FIG. 3, memory areas dedicated to the DMAC linkage, i.e., the DMAC linkage buffers, are preset in the ASIC memory 600 according to the embodiment. Each of the DMAC linkage buffers is set with linkage buffer information.

Herein, the linkage buffer information refers to information including the start address of the DMAC linkage buffer, the memory width of the DMAC linkage buffer, and the number of lines storable in the DMAC linkage buffer. That is, in the embodiment, the linkage buffer information is used as area information. FIG. 3 illustrates start addresses 0, 1, and 2, memory widths 0, 1, and 2, and a line number of 1, for example.

If a DMAC is activated in the linkage mode, one of the thus-set DMAC linkage buffers is used as a temporary memory area for storing intermediate data. In this case, when the DMAC linkage buffer is allocated to be used by the DMAC activated in the linkage mode, the linkage buffer information of the DMAC linkage buffer is notified to the DMAC to allow the DMAC to use the DMAC linkage buffer.

Each of the DMAC linkage buffers is set with a validity value that is set to “valid” or “invalid.” The validity value set to “invalid” indicates that the DMAC linkage buffer is in an unusable state, and the validity value set to “valid” indicates that the DMAC linkage buffer is in a usable state.

In the example illustrated in FIG. 3, therefore, up to three DMAC linkage buffers are usable in accordance with the validity value, but the number of usable DMAC linkage buffers is adjustable. Accordingly, the image forming apparatus 1 according to the embodiment is capable of using a necessary number of DMAC linkage buffers depending on the situation, thereby preventing unnecessary use of the DMAC linkage buffers.

Although FIG. 3 illustrates an example in which each of toggle buffers 0A1, 0A2, 1A1, 1A2, 2A1, and 2A2 corresponds to a single line, the number of lines corresponding to each toggle buffer is not limited to one.

Further, although FIG. 3 illustrates an example in which the start address is set for each of the DMAC linkage buffers, the start address may be set for each of the toggle buffers. Further, if the memory width is set to the maximum value of the size of data to be stored in the DMAC linkage buffer, the DMAC linkage buffer is capable of storing data of any size not exceeding the maximum value. Further, if the data to be stored in the DMAC linkage buffer is not two-dimensional image data but one-dimensional data such as coded data, the DMAC linkage buffer is used as a one-dimensional area having a size of the memory width multiplied by the number of lines.

In a typical image forming apparatus, a software program controls DMAC linkage buffers. For example, in each execution of the DMAC linkage, the software program allocates the DMAC linkage buffer to be used and sets the linkage buffer information of the allocated DMAC linkage buffer.

For the software program, however, it is unnecessary to pay particular attention to the intermediate data temporarily stored in the DMAC linkage buffer, as long as the intermediate data is successfully transferred to the transfer destination.

If the intermediate data is transferred inside the controller ASIC 500 only by hardware control with no need for the software program to pay particular attention to the intermediate data, therefore, the control of the software program is simplified in the DMAC linkage.

In the image forming apparatus 1 according to the embodiment, therefore, the ASIC memory 600 is preset with the DMAC linkage buffers, as illustrated in FIG. 3, and if a DMAC is activated in the linkage mode, the controller ASIC 500 automatically performs the allocation of the DMAC linkage buffer to be used and the notification to the DMAC of the linkage buffer information of the DMAC linkage buffer.

In the image forming apparatus 1 according to the embodiment, therefore, the software program is not required to control the DMAC linkage buffers. Accordingly, the control of the software program in the DMAC linkage is simplified in the image forming apparatus 1 according to the embodiment.

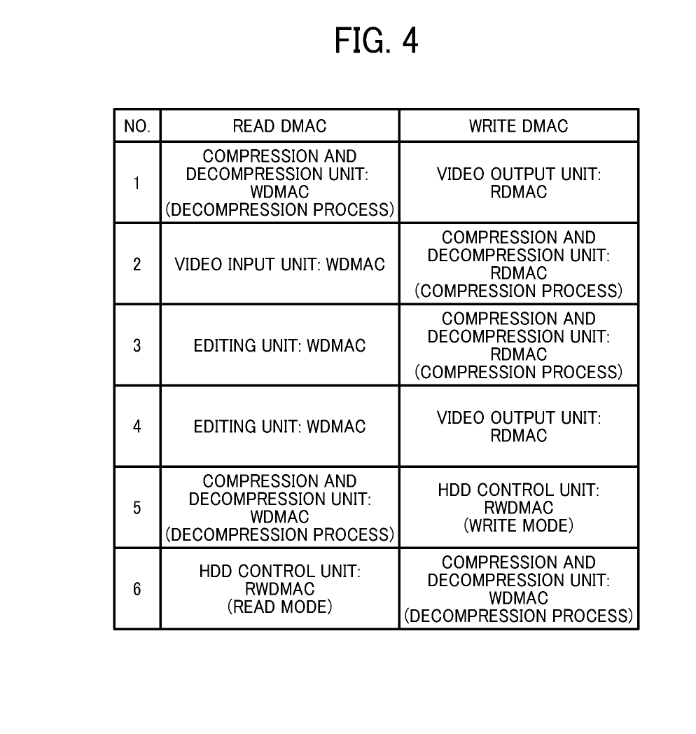

Combinations of modules that perform the DMAC linkage in the controller ASIC 500 according to the embodiment will now be described with reference to FIG. 4.

FIG. 4 is a diagram illustrating an example of combinations of modules that perform the DMAC linkage in the controller ASIC 500 according to the embodiment. As illustrated in FIG. 4, there are six combinations of modules that perform the DMAC linkage in the controller ASIC 500 according to the embodiment.

There is no case in which all combinations of modules illustrated in FIG. 4 operate at the same time. For example, since the third and fourth combinations both include the editing unit 505, the two combinations of modules do not operate at the same time owing to hardware restrictions. Further, for example, even if some of the combinations of modules are not subjected to hardware restrictions and thus may theoretically operate at the same time, there may be no situation in which such combinations of modules operate at the same time.

If the number of DMAC linkage buffers is set to correspond to the number of combinations of modules or the number of DMACs, therefore, one or more of the DMAC linkage buffers will be unused, causing unnecessary memory consumption. It is therefore desirable to set the minimum necessary number of DMAC linkage buffers in consideration of hardware restrictions and possible operating situations.

Returning to FIG. 1, a description will now be given of the linkage buffer information setting unit 511, the linkage buffer information storage unit 512, and the linkage buffer allocation unit 513 of the controller ASIC 500 according to the embodiment.

The linkage buffer information setting unit 511 sets and stores the linkage buffer information and the validity value of each of the DMAC linkage buffers in the linkage buffer information storage unit 512. The linkage buffer information setting unit 511 is implemented by a software program that sets the setting values of registers or a ROM that stores fixed values.

The linkage buffer information storage unit 512 stores the linkage buffer information and the validity value of each of the DMAC linkage buffers. If the linkage buffer information storage unit 512 is implemented by registers, for example, four registers for storing the start address, the memory width, the number of lines, and the validity value are required for each of the DMAC linkage buffers. Therefore, if three DMAC linkage buffers are set, as illustrated in FIG. 3, the linkage buffer information storage unit 512 includes three sets of four registers.

The start address, the memory width, and the number of lines are set only once before shipping or in an initialization process, and are not required to be set in each DMAC linkage. This is because the DMAC linkage buffers according to the embodiment are preset fixed areas, and thus the setting values of the start address, the memory width, and the number of lines remain unchanged once set.

The linkage buffer allocation unit 513 receives a request to allocate a DMAC linkage buffer from a DMAC activated in the linkage mode, and allocates the DMAC having transmitted the request an unused DMAC linkage buffer with the validity value set to “valid.” That is, in the embodiment, the linkage buffer allocation unit 513 functions as an area allocation unit.

In this case, the request to allocate a DMAC linkage buffer may be made by a read DMAC, a write DMAC, or a mechanical unit other than the DMACs. That is, in the embodiment, a read DMAC, a write DMAC, or a mechanical unit other than the DMACs functions as an allocation request unit.

After allocating the DMAC linkage buffer, the linkage buffer allocation unit 513 refers to the linkage buffer information storage unit 512 and notifies the DMAC having transmitted the request of the linkage buffer information of the allocated DMAC linkage buffer. Then, the DMAC notified of the linkage buffer information shares the linkage buffer information with another DMAC that is to operate in linkage with the DMAC, and starts transferring data.

In this case, the linkage buffer allocation unit 513 holds identification information for identifying the DMAC allocated with the DMAC linkage buffer, and notifies the memory controller 502 of the identification information.

Then, if access to the DMAC linkage buffer occurs, the memory controller 502 notified of the identification information determines which one of the DMACs has accessed the DMAC linkage buffer.

If the memory controller 502 determines that the access is not from the DMAC allocated with the DMAC linkage buffer, the memory controller 502 determines that an unexpected access has occurred, and notifies the interrupt control unit 510 of the occurrence of the unexpected access as an interrupt factor.

The interrupt control unit 510 then generates an interrupt for the interrupt factor, and notifies the CPU 100 of the interrupt via the serial communication unit 501. That is, in the embodiment, the interrupt control unit 510 functions as an access interrupt generation unit.

With this configuration, the controller ASIC 500 according to the embodiment is capable of detecting an unexpected memory accesses, thereby facilitating detection of a software bug at a development stage.

As a method allowing the memory controller 502 to locate the DMAC having made the access, a protocol may be designed such that unique identification information allocated to each of the DMACs to identify the DMAC is included in the access request, for example.

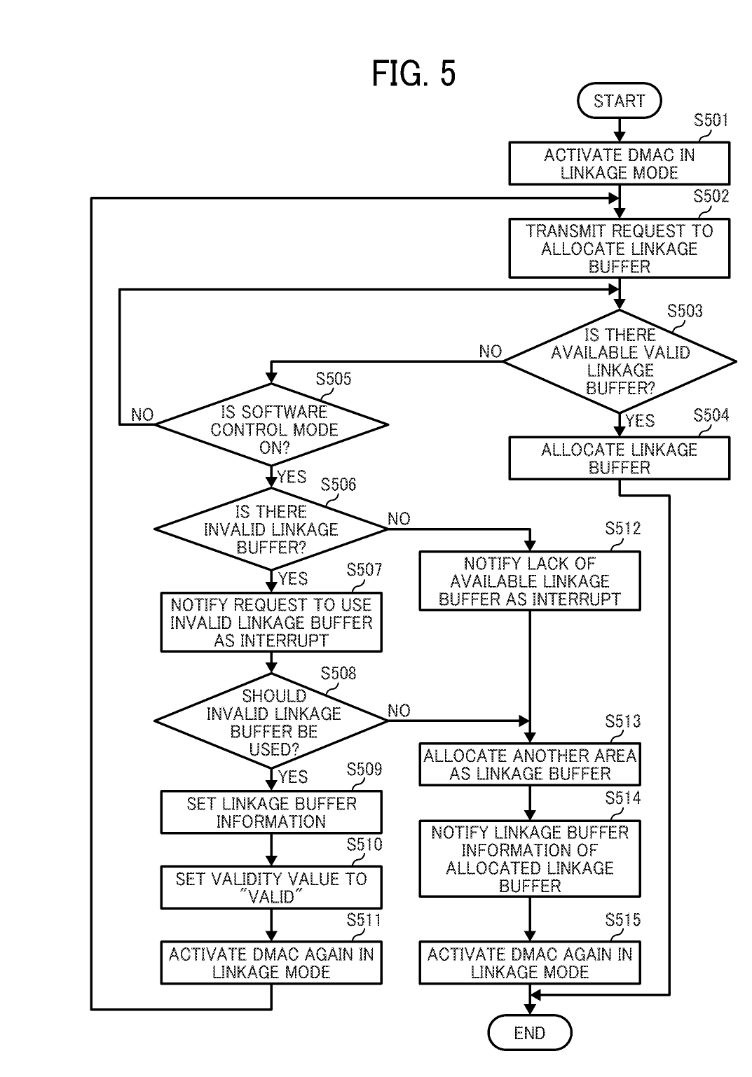

A process of allocating a DMAC linkage buffer performed by the image forming apparatus 1 according to the embodiment will now be described with reference to FIG. 5.

FIG. 5 is a flowchart illustrating a process of allocating a DMAC linkage buffer performed by the image forming apparatus 1 according to the embodiment.

As illustrated in FIG. 5, when the image forming apparatus 1 according to the embodiment allocates a DMAC linkage buffer, the CPU 100 first activates a DMAC subjected to the DMAC linkage in the linkage mode in accordance with the software program (step S501).

The DMAC activated in the linkage mode requests the linkage buffer allocation unit 513 to allocate a DMAC linkage buffer to the DMAC (step S502).

The linkage buffer allocation unit 513 receives the request to allocate a DMAC linkage buffer, refers to the linkage buffer information storage unit 512, and determines whether or not there is any available DMAC linkage buffer with the validity value set to “valid” (step S503).

If the number of DMAC linkage buffers set in the ASIC memory 600 is the same as the number of combinations of DMACs that operate at the same time, there is no case in which all of the DMAC linkage buffers are unavailable at the same time. Meanwhile, if the number of DMAC linkage buffers set in the ASIC memory 600 is less than the number of combinations of DMACs that operate at the same time, all of the DMAC linkage buffers may become unavailable at the same time.

If the linkage buffer allocation unit 513 determines at step S503 that there is an available DMAC linkage buffer with the validity value set to “valid” (YES at step S503), the linkage buffer allocation unit 513 allocates the DMAC linkage buffer to the DMAC having transmitted the request, refers to the linkage buffer information storage unit 512, and notifies the DMAC having transmitted the request of the linkage buffer information of the DMAC linkage buffer (step S504). Thereby, the allocation process is completed.

As described above, in the image forming apparatus 1 according to the embodiment, the DMAC linkage buffers are preset in the ASIC memory 600, and if a DMAC is activated in the linkage mode, the linkage buffer allocation unit 513 automatically performs the allocation of the DMAC linkage buffer to be used by the DMAC and the notification to the DMAC of the linkage buffer information of the DMAC linkage buffer.

In the image forming apparatus 1 according to the embodiment, therefore, the software program is not required to control the DMAC linkage buffers. Accordingly, the control of the software program in the DMAC linkage is simplified in the image forming apparatus 1 according to the embodiment.

If the linkage buffer allocation unit 513 determines at step S503 that there is no available DMAC linkage buffer with the validity value set to “valid” (NO at step S503), the linkage buffer allocation unit 513 determines whether an operation mode is a standby mode or a software control mode (step S505). It is assumed herein that the operation mode is previously set by the linkage buffer allocation unit 513.

If the linkage buffer allocation unit 513 determines at step S505 that the operation mode is the standby mode (NO at step S505), the linkage buffer allocation unit 513 causes the DMAC to stand by until one of valid DMAC linkage buffers becomes available. Then, the linkage buffer allocation unit 513 regularly performs a process similar to that of step S503. That is, in the embodiment, the linkage buffer allocation unit 513 functions as a standby instruction unit.

If the linkage buffer allocation unit 513 determines at step S505 that the operation mode is the software control mode (YES at step S505), the linkage buffer allocation unit 513 refers to the linkage buffer information storage unit 512, and determines whether or not there is any DMAC linkage buffer with the validity value set to “invalid” (step S506).

If the linkage buffer allocation unit 513 determines at step S506 that there is a DMAC linkage buffer with the validity value set to “invalid” (YES at step S506), the linkage buffer allocation unit 513 notifies the interrupt control unit 510 of the request to use the DMAC linkage buffer as an interrupt factor. Then, the interrupt control unit 510 generates an interrupt for the request to use the DMAC linkage buffer, and notifies the CPU 100 of the interrupt via the serial communication unit 501 (step S507). That is, in the embodiment, the interrupt control unit 510 functions as an allocation interrupt generation unit.

Notified of the interrupt by the interrupt control unit 510, the CPU 100 determines whether or not to use the DMAC linkage buffer with the validity value set to “invalid” in accordance with the software program (step S508).

If the CPU 100 determines to use the DMAC linkage buffer with the validity value set to “invalid” at step S508 (YES at step S508), the linkage buffer information setting unit 511 sets in the linkage buffer information storage unit 512 the linkage buffer information of the DMA linkage buffer with the validity value set to “invalid” (step S509), and sets the validity value to “valid” (step S510). That is, in the embodiment, the linkage buffer information setting unit 511 functions as a use state setting unit.

Then, the CPU 100 again activates the DMAC subjected to the DMAC linkage in the linkage mode in accordance with the software program (step S511), and the DMAC activated in the linkage mode performs a process similar to that of step S502.

If the linkage buffer allocation unit 513 determines at step S506 that there is no DMAC linkage buffer with the validity value set to “invalid” (NO at step S506), the linkage buffer allocation unit 513 notifies the interrupt control unit 510 that all of the DMAC linkage buffers are unavailable as an interrupt factor. Then, the interrupt control unit 510 generates an interrupt for the lack of an available DMAC linkage buffer, and notifies the CPU 100 of the interrupt via the serial communication unit 501 (step S512).

If the CPU 100 is notified of the interrupt by the interrupt control unit 510, or if the CPU 100 determines not to use the DMAC linkage buffer with the validity value set to “invalid” at step S508 (NO at step S508), the CPU 100 allocates another area in the ASIC memory 600 as a DMAC linkage buffer in accordance with the software program (step S513).

The CPU 100 then notifies the DMAC activated in the linkage mode of the linkage buffer information of the allocated DMAC linkage buffer in accordance with the software program (step S514), and again activates the DMAC subjected to the DMAC linkage in the linkage mode (step S515). Thereby, the allocation process is completed.

In this case, the CPU 100 activates the DMAC in the linkage mode in accordance with the software program under the control of the software program. Thus, the DMAC linkage is performed by the control of the software program, i.e., by the existing method, without the request for allocation of a DMAC linkage buffer from the activated DMAC.

With this configuration, the image forming apparatus 1 according to the embodiment is capable of performing the DMAC linkage in accordance with the control of the software program, i.e., in the existing method, when it is determined not to use the preset DMAC linkage buffers.

As described above, in the image forming apparatus 1 according to the embodiment, the DMAC linkage buffers are preset in the ASIC memory 600, and if a DMAC is activated in the linkage mode, the linkage buffer allocation unit 513 automatically performs the allocation of the DMAC linkage buffer to be used and the notification to the DMAC of the linkage buffer information of the DMAC linkage buffer.

In the image forming apparatus 1 according to the embodiment, therefore, the software program is not required to manage the DMAC linkage buffers. Accordingly, the control of the software program in the DMAC linkage is simplified in the image forming apparatus 1 according to the embodiment.

Although the DMAC linkage buffers are preset in the ASIC memory 600 in the foregoing example of the embodiment, the DMAC linkage buffers may be set in the CPU memory 200 or in both the ASIC memory 600 and the CPU memory 200.

Further, although the DMAC linkage buffers are preset in the ASIC memory 600 connected to the controller ASIC 500 in the foregoing example of the embodiment, the controller ASIC 500 may be connected only to the CPU memory 200 and not to the ASIC memory 600, and the DMAC linkage buffers may be preset in the CPU memory 200.

Further, although the foregoing example of the embodiment is an image forming apparatus including the controller ASIC 500 as a data transfer control device, this disclosure is also applicable to an information processing apparatus such as a personal computer (PC) including the controller ASIC 500.

This disclosure simplifies the control of the software program in the DMAC linkage, such as management of memory areas used in the DMAC linkage and settings necessary for the DMAC linkage, for example.

Numerous additional modifications and variations are possible in light of the above teachings. For example, elements or features of different illustrative and embodiments herein may be combined with or substituted for each other within the scope of this disclosure and the appended claims. Further, features of components of the embodiments, such as number, position, and shape, are not limited to those of the disclosed embodiments and thus may be set as preferred. Further, the above-described steps are not limited to the order disclosed herein. It is therefore to be understood that, within the scope of the appended claims, this disclosure may be practiced otherwise than as specifically described herein.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

This disclosure can be implemented in any convenient form, for example using dedicated hardware, or a mixture of dedicated hardware and software. This disclosure may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since this disclosure can be implemented as software, each and every aspect of this disclosure thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A data transfer control device comprising:
a memory;
at least a first direct memory access controller to request to allocate a memory area in the memory to the first direct memory access controller in response to an instruction to perform linked data transfer with a second direct memory access controller via the memory, the first direct memory access controller and the second direct memory access controller being different from each other; and
an area allocation unit to allocate a memory area in the memory to the first direct memory access controller in accordance with the request to allocate from the first direct memory access controller,
wherein the first direct memory access controller allocated with the memory area in the memory performs the linked data transfer with the second direct memory access controller via the allocated memory area in the memory in accordance with respective operating states of the first direct memory access controller and the second direct memory access controller.

2. The data transfer control device of claim 1, wherein the first direct memory access controller allocated with the memory area performs the linked data transfer via the allocated memory area based on area information of the allocated memory area.

3. The data transfer control device of claim 1, wherein the memory is dedicated to the data transfer control device.

4. The data transfer control device of claim 1, further comprising an interrupt control unit to generate an interrupt if the allocated memory area is accessed by a direct memory access controller different from the first direct memory access controller allocated with the memory area.

5. The data transfer control device of claim 4, wherein the interrupt control unit generates the interrupt if the memory has no memory area available to be allocated when the first direct memory access controller requests the area allocation unit to allocate a memory area in the memory.

6. The data transfer control device of claim 1, wherein if the memory has no memory area available to be allocated when the first direct memory access controller requests the area allocation unit to allocate a memory area in the memory, the area allocation unit causes the first direct memory access controller to stand by until a memory area in the memory becomes available to be allocated.

7. The data transfer control device of claim 1, further comprising a use state setting unit to set a memory area in the memory in one of a usable state and an unusable state.

8. The data transfer control device of claim 7, wherein if the memory has no memory area available to be allocated when the first direct memory access controller requests the area allocation unit to allocate a memory area in the memory, the use state setting unit switches a memory area in the memory set in the unusable state to the usable state.

9. An information processing apparatus comprising the data transfer control device of claim 1.

10. An image forming apparatus comprising the data transfer control device of claim 1.

11. A data transfer control method performed by a data transfer control device including a memory, at least a first direct memory access controller, and an area allocation unit, the data transfer control method comprising:
transmitting from the first direct memory access controller to the area allocation unit a request to allocate a memory area in the memory to the first direct memory access controller in response to an instruction to perform linked data transfer between the first direct memory access controller and a second direct memory access controller via the memory, the first direct memory access controller and the second direct memory access controller being different from each other;
allocating a memory area in the memory to the first direct memory access controller in accordance with the request to allocate a memory area in the memory; and
performing the linked data transfer between the first direct memory access controller and the second direct memory access controller via the memory area allocated to the first direct memory access controller in accordance with respective operating states of the first direct memory access controller and the second direct memory access controller.
